(19) United States
(12) Patent Application Publication
(10) Pub. No.: US 2010/0328957 A1
(43) Pub. Date: Dec. 30, 2010

(54) Ink Receptive Substrate

(76) Inventor: Jacko Hessing, Holland (NL)

Correspondence Address: MORGAN LEWIS & BOCKIUS LLP, 1111 PENNSYLVANIA AVENUE NW, WASHINGTON, DC, 20004, US

(21) Appl. No.: 12/866,934

(22) PCT Filed: Mar. 16, 2009
(86) PCT No.: PCT/GB2009/050251

§ 371 Date: Aug. 10, 2010

(30) Foreign Application Priority Data
Mar. 20, 2008 (GB) 0805254.0
Apr. 1, 2008 (EP) 08006663.2

(51) Int. Cl. B41J 2/015; B05D 3/02; B41M 5/00; F21V 11/00

(52) U.S. Cl. 362/311.01; 427/256; 428/32.26; 347/20

(57) ABSTRACT

A process for preparing an ink receptive substrate comprising the steps of:
(i) contemporaneously applying a first and a second curable composition to a support such that the first composition is closer to the support than the second composition;
(ii) allowing the first and second compositions to diffuse into each other to provide an inhomogeneous, curable coating on the support; and
(iii) curing the inhomogeneous coating to form a polymer layer having a lower porosity nearer the support than further away from the support.

This invention relates to substrates suitable for use in inkjet printing and to processes for their manufacture and use.

In a typical ink-jet recording or printing system, ink droplets are ejected from a nozzle at high speed towards a substrate to produce an image thereon. The ink droplets, or recording liquid, generally comprise a colorant, e.g. a dye or pigment, and a relatively large amount of liquid medium in order to prevent clogging of the nozzle. The liquid medium typically comprises organic solvents, but may also mainly comprise UV curable monomers, water and organic solvent or other components.

Ink jet printing is increasingly used to prepare advertisements for display in light boxes both during daylight hours and at night. The light boxes are typically displayed in open areas such as stations, airport lounges, shopping malls and phone booths. Some of the light boxes contain a long strip of several advertisements which display, one after another, by rolling the advertisements from one roller to another.

In order to achieve brilliance and fine outlines, the advertisement often needs a high light transmittance (to let more light through from behind, e.g. from a bulb or fluorescent light tube) and high whiteness (e.g. to take advantage of reflected light during daylight hours). These requirements are often conflicting because the white pigments used to provide whiteness under daylight conditions can impair light transmittance, thereby reducing brightness when the advertisement is illuminated from behind at night time.

EP-A-0156532 describes an inkjet substrate comprising a porous layer of homogeneous structure.

International Patent Publication WO2005/016655 describes an ink-jet recording medium comprising a support and an ink receiving layer comprising two discrete parts: a dense top layer and a microporous sublayer.

International Patent Publication WO2007/018425 describes the simultaneous coating of three curable compositions onto a support using a slide coating machine. All three layers had very similar, high water:organic solvent ratios which would have caused phase separation in all three layers.

A further problem of many printed substrates is their poor scratch resistance. Scratching can significantly mar the appearance of the printed substrate.

The present invention sets out to provide substrates suitable for use in inkjet printing which have good scratch resistance Many of the substrates may possess a valuable combination of good light transmittance and brightness, making them particularly useful in day and night light box advertising.

According to a first aspect of the present invention there is provided a process for preparing an ink receptive substrate comprising the steps of:
(i) contemporaneously applying a first and a second curable composition to a support such that the first composition is closer to the support than the second composition;
(ii) allowing the first and second compositions to diffuse into each other to provide an inhomogeneous, curable coating on the support; and
(iii) curing the inhomogeneous coating to form a polymer layer having a lower porosity nearer the support than further away from the support.

Particularly good results can be achieved when the first and second curable compositions are chosen such that a polymer resulting from curing the first curable composition is relatively soluble and a polymer resulting from the second curable composition is relatively insoluble in aqueous media. In order to determine the relative solubilities of these resultant polymers one can prepare them individually (i.e. separate from the other curable composition) using the same conditions as the process of the present invention but without any contact with the other curable composition. In this way the solubility of the polymer arising from the ‘pure’ first or second composition, without any diffusion, is assessed.

Preferably in step (ii) the first and second compositions diffuse into each other to provide an inhomogeneous, curable coating without any phase separation occurring. The inhomogeneous nature of the inhomogeneous, curable coating arising from step (ii) is preferably due to the uneven concentration of its individual components about its depth. On the other hand it is preferred that phase separation occurs during curing step (iii).

Preferably the first curable composition is a curable composition which does not phase separate when cured in the absence of the second curable composition.

Preferably the second curable composition is a curable composition which does phase separate when cured in the absence of the first curable composition.

One may determine whether a curable phase separates when cured in the absence of the other curable composition by applying it alone to the support and curing it and observing whether any phases separation occurs.

Thus in one embodiment the first and a second curable compositions each independently comprise one or more curable compounds and an aqueous liquid medium and the curable compounds are selected such that when a polymer is obtained by curing the first and second compositions individually, the solubility of the polymer arising from the first curable composition in the liquid medium of the first composition is higher than the solubility of the polymer arising from curing the second composition in the liquid medium of the second composition. The difference in solubility can be achieved in several ways as discussed below.

Preferably the first composition is in contact with the support.

The conditions used for curing the first and second compositions are identical to those used in the process of the present invention except that only the composition under examination is applied to the substrate and therefore there is no possibility of any diffusion between the first and second curable compositions.

On completion of curing, the polymers arising from both the first and second curable compositions will be insoluble in their respective liquid media. However the relatively higher solubility of the polymer from the first composition compared to the polymer from the second composition can be seen when the latter polymer (derived from the second curable composition) phase separates during curing (e.g. to give a cloudy or opaque layer, which becomes porous after drying) while the former polymer (derived from the first curable composition) does not phase separate during curing (resulting in a dense, often transparent layer). In the case that the formed polymer is the same in both compositions the difference in relative solubility is due to differences in the liquid medium.

In another embodiment the first and a second curable compositions each independently comprise one or more curable compounds and an aqueous liquid medium and the solubility of the curable compound(s) of the first composition in the liquid medium of the first composition is higher than the solubility of the curable compound(s) of the second composition in the liquid medium of the second composition (preferably at least 2% higher, more preferably at least 5% higher. When a curable composition comprises more than one curable compound the solubility referred to here is the solubility of the curable compounds in total. In one embodiment the solubility is the number of grams of curable compound(s) which may be dissolved in 100 cm³ of liquid medium in order to reach cloud point (e.g. when the mixture starts to demix/phase separate).

The extent to which the first and second compositions diffuse into each other determines the extent to which the coating is inhomogeneous. For example, when the first and second compositions diffuse into each other to only a small extent, the coating at the time of curing may comprise a lower region which is entirely the first composition, a mixed region which comprises a mixture of the first and second compositions and an upper (but not necessarily topmost) region which is entirely the second composition. On the other hand, a greater degree of diffusion results in an inhomogeneous coating where there are no regions having the original formulation of the first and second curable compositions and instead there is a compositional gradient (which may be gradual or less than gradual) throughout the depth of the inhomogeneous layer.

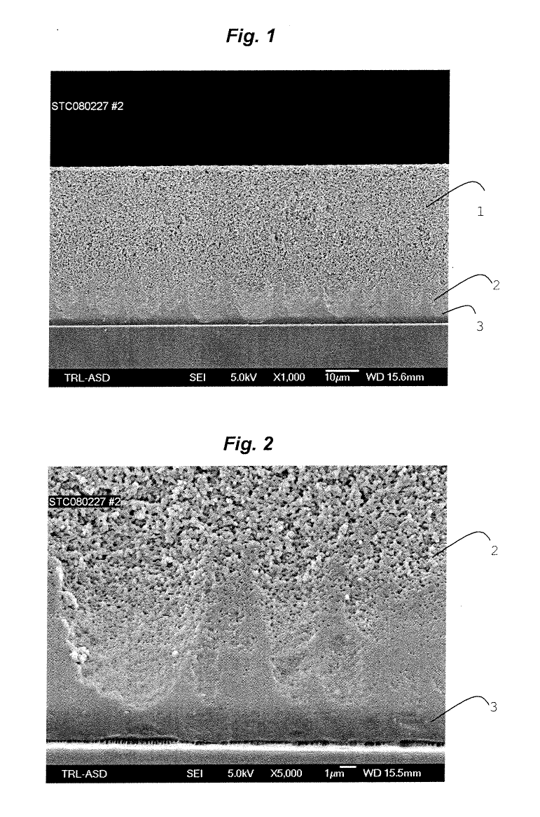

FIG. 1 shows a SEM picture of a cross section of an ink receptive substrate prepared by the process of the present invention (Example 2).

FIG. 2 shows an enlargement of the bottom part of FIG. 1.

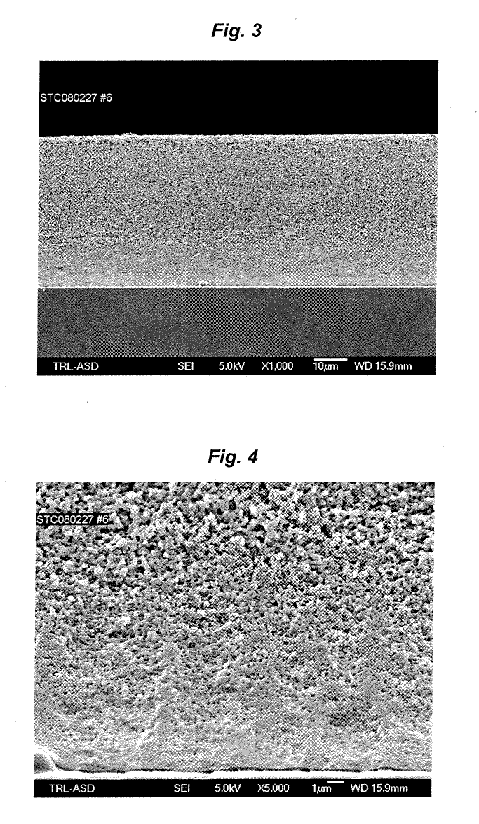

FIG. 3 shows a SEM picture of a cross section of an ink receptive substrate prepared by the process of the present invention (Example 4).

FIG. 4 shows an enlargement of the bottom part of FIG. 3.

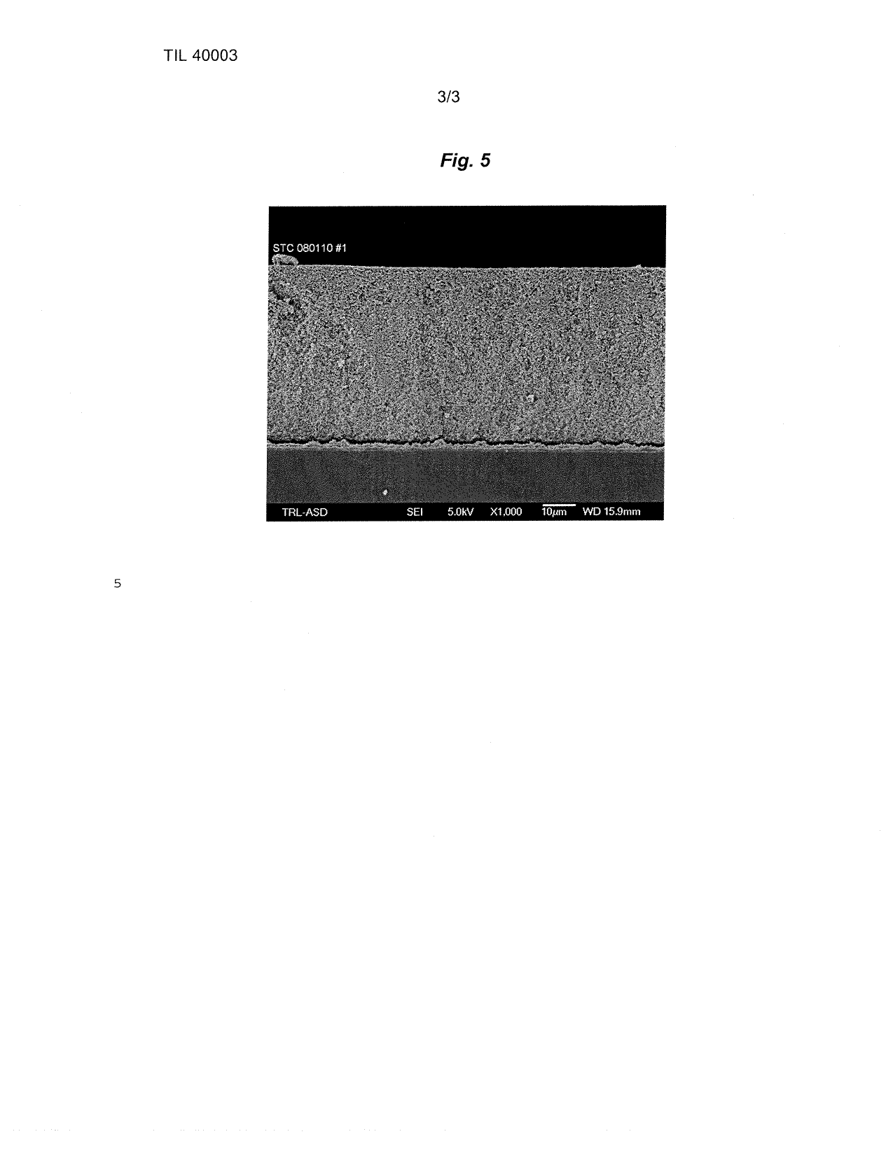

FIG. 5 shows a SEM picture of a cross section of a comparative ink receptive substrate (Comparative Example 1).

In FIG. 1 there can be seen a porous region (1) derived from the second curable composition, a non-porous region (3) derived from the first composition and a mixed intermediate region (2) derived from partial diffusion of the first and second compositions into each other (the wavy line has been caused by cross-sectional cutting of the sample). Regions (2) and (3) can be seen in greater detail in the enlargement shown as FIG. 2.

FIGS. 3 and 4 show Example 4 wherein the essentially non-porous region is less distinct but still sufficient for a good scratch resistance.

Preferably the porosity of the polymer at its surface in contact with the support is below 15%, more preferably below 10%.

Preferably the porosity of the polymer at its surface furthest away from the support is greater than 15%, more preferably greater than 20%.

The porosity of the polymer may be determined by scanning electron microscopy (“SEM”). For example, the first and second curable compositions may be cured separately under the conditions used in the process and their porosities measured using SEM.

The % porosity may be calculated, if desired, by coating and curing the curable composition of interest onto a support (whether it be the first or the second curable composition), curing the composition under the conditions used in the process, measuring the dry thickness of the resultant, cured polymer and performing the following calculation:

% porosity=(DT/CA×100%)−100%

wherein:

DT is the dry thickness of the resultant, cured polymer in micrometers; and

CA is the coated amount of non-volatile compounds in grams per m². Preferably curing causes phase separation in the second region, but not the first region. As a resultant the polymer layer generally has one side nearest the support which is impermeable to liquids (derived from the first curable composition which did not phase separate) and another side which is liquid permeable (derived from the composition which did phase separate).

If desired one or more further curable compositions may be applied on top of the second curable composition, preferably contemporaneously with the first and second compositions.

Preferably the wet thickness of the inhomogeneous coating (whether derived from only the first and second curable compositions or from a combination of these compositions with further curable compositions layered on top) is less than 300 microns more preferably less than 150 microns. This preference arises because with greater coating thicknesses it can be more difficult to cure the entire depth, e.g. when curing by irradiation the light might not reach the lower layer(s) of a very thick coating and cure may be incomplete or non-existent.

The contemporaneous application of the curable composition to the support may be performed by any suitable method, for example by curtain coating, extrusion coating, slide coating or slot die coating.

High speed coating machines are commercially available for the contemporaneous application of liquids to a rapidly moving support. These machines allow coating speeds of over 15 m/min, e.g. more than 20 m/min or even higher, with 30 m/min being fairly typical, but higher speeds such as over 60 m/min, over 120 m/min, or even up to about 400 m/min being possible.

When the first and second curable composition are applied to the support using a high speed coating machine it is preferred that they each have a viscosity below 4000 mPa·s when measured at 35° C., more preferably from 1 to 1000 mPa·s when measured at 35° C. Most preferably the viscosity of the curable compositions is from 1 to 500 mPa·s when measured at 35° C. For coating methods such as slide bead coating the preferred viscosity is from 1 to 100 mPa·s when measured at 35° C. The lower viscosities enable the compositions to be applied rapidly to the support and enable the ink receptive substrates to be mass produced on a fast-moving production line.

While it is possible to prepare the ink receptive substrate on a batch basis using a stationary support, to gain full advantage of the invention it is much preferred to prepare the ink receptive substrate on a continuous basis using a moving support. The support may be in the form of a roll which is driven continuously from one spool to another, or the support may rest on a continuously driven belt. Using such techniques the curable compositions can be applied to the support on a continuous basis or they can be applied on a large batch basis.

Thus in a preferred process the curable compositions are applied continuously to the support by means of a manufacturing unit comprising a curable composition application station, an irradiation source, an ink receptive substrate collecting station and a means for moving a support from the curable composition application station to the irradiation source and to the ink receptive substrate collecting station.

The curable composition application station may be located at an upstream position relative to the irradiation source and the irradiation source may be located at an upstream position relative to the ink receptive substrate collecting station.

The curable composition application station preferably comprises a first slot through which the first curable composition is applied to the support and a second slot through which the second curable composition is applied to the support. Further slots may also be included if desired, for example to apply one or more further curable compositions on top of the second curable composition.

The curable compositions may come into contact with each other for the first time during, after or more preferably before the first curable composition contacts the support.

By allowing the first and second curable compositions to partly diffuse into each other before curing, a strong adhesion is formed between the resultant polymer and the support. The polymer formed on curing typically comprises a relatively non-porous region derived from the first region in which no phase separation occurred and a relatively porous region derived from the second region in which phase separation did occur. Further curable compositions may also be applied and generally these will be formulated so that they phase separate on curing in order to provide further porous polymer layers capable of receiving ink. The composition of each curable layer may be varied as desired. Further enhancement of the adhesion may be achieved by selecting curable compounds capable of forming H-bridges or by increasing the crosslink density.

The first composition is preferably applied to the support in an amount of 5 to 75 g/m², more preferably 7 to 40 g/m² and especially 10 to 20 g/m².

The second composition is preferably applied to the support in an amount of 40 to 295 g/m², more preferably 50 to 200 g/m² and especially 60 to 150 g/m².

To obtain a polymer having a porous region and a non-porous region (or a region with low porosity) the first and second curable compositions are typically different from each other. This difference may be achieved in a number of ways. For example, one may use different curable compounds in the first and second curable composition. The amounts of the curable compounds used in the first and second curable compositions may be different, regardless of whether the identity of the curable compounds in each curable composition is the same, in order to achieve a difference in phase separation properties and hence a region in which phase separation does take place and a region in which no phase separation takes place. The difference in phase separation properties between the first and second curable compositions may also be achieved by including different amounts and/or different types of organic solvents in the curable compositions, irrespective of whether the curable compounds or their amounts are the same or different. One may prevent phase separation in a first region largely or wholly derived from the first composition by formulating the composition such that the cured polymer arising from curing is largely soluble therein. For example, one may include significantly more water-miscible organic solvent in the first curable composition than in, for example, the second curable composition, whereby on curing the first curable composition does not phase separate and the second curable composition does phase separate. Alternatively, or additionally, one may include a more powerful organic solvent in the first curable composition than in the second curable composition.

Preferably the part of the ink receptive layer derived from where the compositions have diffused into each other, hereinafter abbreviated as the mixed region, has a gradual porosity gradient with porosity increasing as the distance from the support increases. In a preferred embodiment the porosity gradient is sufficiently gradual that examination of a section through the resultant ink receptive substrate by scanning electron microscope does not reveal a discrete line junction parallel to the surface of the substrate where the part of the ink receptive layer derived from the first composition meets the part derived from the second composition.

The identity and ratio of curable compounds in each of the curable compositions may also be tailored to favour or discourage phase separation, for example hydrophilic monomers discourage phase separation from aqueous curable compositions whereas hydrophobic monomers favour phase separation in such compositions.

It was found that a gradual change in the polymer's porosity enhances a good scratch resistance. When the first curable composition is applied to the support, then cured, followed by the application and subsequent curing of the second curable composition, a very sharp transition from non-porous to porous was obtained and the scratch resistance was often poor. Without wishing to be bound by any theory, the gradual change in porosity which may be achieved by the process of the present invention may allow a more even distribution of the shear stress that may arise upon scratching the porous polymer layer, over a larger region.

A convenient method for forming a polymer having a lower porosity nearer the support than further away from the support is to include more water-miscible organic solvent in the first composition. For example, in one embodiment the first curable composition may comprise at least 5 wt %, more preferably at least 10 wt % more organic solvent than the second curable composition, relative to the total weight of the composition (e.g. if the second curable composition comprises 14 wt % organic solvent the first curable composition preferably comprises at least 19 wt %, more preferably at least 24 wt % in total of organic solvent(s)). In another embodiment the weight ratio of organic solvents to water in the first curable composition is preferably at least 10% higher than in the second curable composition, more preferably at least 20% higher, even more preferably at least 40% higher (e.g. if the second curable composition has a ratio of total organic solvent(s) to water of 0.5:1, the first curable composition preferably has a ratio of at least 0.55:1, more preferably at least 0.6:1 and especially 0.7:1). The preferred ratio depends to some extent on the types of curable compounds in both compositions and on the types of organic solvents.

Typically one will choose a first curable composition which is a clear solution far from cloud point and a second curable composition which is a clear solution near to cloud point.

Preferably more of the second curable composition is applied to the support than first curable composition, more preferably at least twice the amount by weight, especially at least three times the amount by weight, more especially 4 to 6 times the amount by weight.

In one embodiment, the most water-soluble curable compound in the first curable composition has a higher water-solubility than the most water-soluble curable compound in the second curable composition.

When the first and second curable compositions are applied to the support first and second regions may form (though not necessarily in an obvious or distinct manner) and the curable compounds may diffuse between the curable compositions, e.g. from the second to the first curable composition and/or vice versa. In general diffusion of the most water-soluble curable compound from the first to the second curable composition will not prevent phase separation in the second region because the lower soluble compound(s) derived from the second curable composition usually dominate the phase inversion reaction.

When the first curable composition comprises less organic solvent than the second curable composition, even when the first curable composition is far from its cloud point, diffusion of a curable compound of lower water-solubility from the second curable composition to the first curable composition may initiate phase inversion in the first region due to the dominance of the lower soluble compound in the reaction. In general the latter phenomenon is not preferred because the complete layer will be porous which might in some cases negatively influence the scratch resistance of the ink receptive layer.

One may determine whether the first or second composition can form a region which phase separates during curing by curing the composition in isolation under the conditions intended to be used in the process. If phase separation occurs the resultant polymer is opaque (e.g. white) in appearance whereas if no phase separation occurs the resultant polymer is usually transparent.

As examples of water-miscible organic solvents which may be used in the curable compositions there may be mentioned: C₁₋₆-alkanols, preferably methanol, ethanol, propan-1-ol, propan-2-ol, n-butanol, sec-butanol, tert-butanol, n-pentanol, cyclopentanol and cyclohexanol; linear amides, preferably dimethylformamide or dimethylacetamide; ketones and ketone-alcohols, preferably acetone, methyl ether ketone, cyclohexanone and diacetone alcohol; water-miscible ethers, preferably tetrahydrofuran and dioxane; diols, preferably diols having from 2 to 12 carbon atoms, for example pentane-1,5-diol, ethylene glycol, propylene glycol, butylene glycol, pentylene glycol, hexylene glycol and thiodiglycol and oligo- and poly-alkyleneglycols, preferably diethylene glycol, triethylene glycol, polyethylene glycol and polypropylene glycol; triols, preferably glycerol and 1,2,6-hexanetriol; mono-C₁₋₄-alkyl ethers of diols, preferably mono-C₁₋₄-alkyl ethers of diols having 2 to 12 carbon atoms, especially 2-methoxyethanol, 2-(2-methoxyethoxy)ethanol, 2-(2-ethoxyethoxy)-ethanol, 2-[2-(2-methoxyethoxy)ethoxy]ethanol, 2-[2-(2-ethoxyethoxy)-ethoxy]-ethanol and ethyleneglycol monoallylether; cyclic amides, preferably 2-pyrrolidone, N-methyl-2-pyrrolidone, N-ethyl-2-pyrrolidone, caprolactam and 1,3-dimethylimidazolidone; cyclic esters, preferably caprolactone; sulphoxides, preferably dimethyl sulphoxide and sulpholane. For practical reasons the water-soluble organic solvent preferably has a low evaporation rate, i.e. a low vapour pressure, for example a vapour pressure below 10 kPa, more preferably below 5 kPa, even more preferably below 2 kPa, in each case as measured at 20° C. The preferred water-miscible organic solvents are propan-2-ol and diacetone alcohol.

One may subject the support, if desired, to a corona discharge treatment, glow discharge treatment, flame treatment, ultraviolet light irradiation treatment or the like, e.g. for the purpose of improving its wettability and the ability of the polymer to adhere thereto.

Preferably the ink receptive substrate has an average surface pore diameter of 0.02 to 1.2 microns, preferably 0.05 to 0.7 microns. The term “surface pore” refers to the pores visible on the surface of the ink receptive substrate. The “surface pore diameter” refers to the diameter of these pores. For noncircular pores the pore diameter may be taken as the diameter of a circle having the same surface area as the noncircular pore.

The dry thickness of the polymer is preferably 10 to 300 microns, more preferably 20 to 150 microns even more preferably 30 to 90 microns. When the ink receptive substrate is a multilayer comprising more than 2 layers the thickness of the various layers can be selected freely depending on the properties one wishes to achieve.

The curable compositions preferably each comprise water, one or more organic solvents, one or more curable compounds and optionally one or more photoinitiators.

Preferred curable compounds are difunctional compounds and polyfunctional compounds, optionally including one or more monofunctional compounds.

Examples of suitable difunctional compounds include poly(ethylene glycol) diacrylates, poly(ethylene glycol) divinyl ethers, poly(ethylene glycol) diallyl ethers, Bisphenol A ethoxylate diacrylate, neopentyl glycol ethoxylate diacrylate, propanediol ethoxylate diacrylates, butanediol ethoxylate diacrylates, hexanediol ethoxylate diacrylates, poly(ethylene glycol-co-propylene glycol) diacrylates, poly(ethylene glycol)-block-poly(propylene glycol)-block-poly(ethylene glycol) diacrylates and combinations thereof.

Examples of suitable polyfunctional compounds include glycerol ethoxylate triacrylate, trimethylolpropane ethoxylate triacrylate, trimethylolpropane ethoxylate triacrylate, pentaerythrytol ethoxylate tetraacrylate, ditrimethylolpropane ethoxylate tetraacrylate, dipentaerythrytol ethoxylate hexaacrylate and combinations thereof.

Examples of suitable monofunctional compounds include 2-hydroxyethyl acrylate, 2-hydroxyethyl methacrylate, polyethylene glycol monoacrylate, polyethylene glycol monomethacrylate, hydroxypropyl acrylate, hydroxypropyl methacrylate, polypropylene glycol monoacrylate, polypropylene glycol monomethacrylate, 2-methoxyethyl acrylate, 2-phenoxyethyl acrylate, 2-phenoxyethyl methacrylate and combinations thereof.

Preferably the curable compositions each independently comprise a curable compound having at least two acrylic groups. Acrylic groups are preferred because of their high reactivity.

Many curable compounds are hydrophobic in nature and require high concentrations of organic apolar solvents to obtain a clear solution. Large amounts of volatile organic solvents are not preferred since these may result in hazardous conditions in the production area during the drying phase of the membrane while non-volatile solvents are difficult to remove and are thus not preferred either. Some curable compounds are water-reducible to form an aqueous solution. A compound is regarded as water reducible when at 25° C. at least 2 wt % of water is miscible with the curable compound. Preferably at least 4 wt %, more preferably at least 10 wt % of water is miscible with the curable compounds of the invention.

The weight ratio of organic solvent to water in the second curable composition preferably is less than 2 to 1, more preferably less than 1 to 1, even more preferably less than 1 to 2. The weight ratio of organic solvent to water in the first curable composition may be higher than in the second curable composition. In case the miscibility with water is not sufficient to dissolve the curable compound completely, inclusion of an organic solvent, particularly a water-miscible organic solvent, is desirable.

In one embodiment the second curable composition does not contain an organic solvent. For example, as second curable composition one may use 10% CN132, 27.5% CN435 and 62.5%, or 21.5% CN132, 21.5% CN435 and 57% water may be used, or 60% CN132 and 40% water, or 49.75% CN132, 49.75% water and 0.5% dodecyltrimethylammonium chloride to give a favourable porous matrix suitable for receiving ink. CN132 and CN435 are curable monomers available from Cray Valley, France. CN435 (available in the USA as SR9035) is an ethoxylated trimethylolpropane triacrylate.

Preferred organic solvents are as described above for the first curable composition.

The solubility of the curable compound in the solvent is another parameter which can affect whether phase inversion takes place.

Preferably the curable compositions are clear solutions. The organic solvent(s) used in the curable compositions can be chosen such that the selected curable compound(s) are completely dissolved. A clear solution is more stable and is generally preferred. However a slight turbidity usually does not cause instability and is in most cases acceptable, particularly for the second and any subsequent curable compositions which are intended to phase separate. For curing to cause phase separation to occur in the second region the growing polymer arising from the second curable composition is preferably insoluble in the second curable composition. This places certain restrictions to the curable compounds that can be selected in combination with a certain organic solvents.

Possible methods that can facilitate the selection of suitable combinations of curable compounds and organic solvents in order to facilitate or prevent phase separation in the first and second regions are described in e.g. EP-A-216622 (cloud point) and U.S. Pat. No. 3,823,027 (Hansen system). To obtain a large difference in solubility between the curable compounds and the resulting polymer and thus a fast phase separation in the second region and in any subsequently applied curable compositions preferably the molecular weight (MW) of the curable compounds is not too large, although even with high-MW curable compounds phase separation can be realized by careful selection of the solvent. Preferably the MW of any curable compounds used in the second and any subsequent curable composition (whether they be monomers or oligomers) is less than 10,000 Daltons, more preferably less than 5,000 Daltons. Particularly good results are obtained with curable compounds having a MW of less than 1,000 Daltons.

In addition to the curable compound having a water reducibility of, for example, 2 to 50 wt %, other types of curable monomers may be present in the curable compositions, e.g. epoxy compounds, oxetane derivatives, lactone derivatives, oxazoline derivatives, cyclic siloxanes, or ethenically unsaturated compound such as acrylates, methacrylates, polyene-polythiols, vinylethers, vinylamides, vinylamines, allyl ethers, allylesters, allylamines, maleic acid derivaties, itacoic acid derivaties, polybutadienes and styrenes. Preferably the curable compound is one or more (meth)acrylate compound, for example such as alkyl-(meth)acrylates, polyester-(meth)acrylates, urethane-(meth)acrylates, polyether-(meth)acrylates, epoxy-(meth)acrylates, polybutadiene-(meth)acrylates, silicone-(meth)acrylates, melamine-(meth)acrylates, phosphazene-(meth)acrylates, (meth)acrylamides and combinations thereof because of their high reactivity. Other types of curable compounds may be included in the curable composition in order to modify certain characteristics of the resulting ink receptive substrate.

If desired one may select a particular combination of curable composition and processing conditions in order to tailor the end properties of the ink receptive substrate to those which are desired. Upon curing, the curable compound(s) polymerise to gradually form the polymer. During this process the solubility of the growing polymer in the compositions decreases, resulting in phase separation in the second region (where the resultant polymer has a relatively lower solubility in the second composition). However the part of the polymer which is in the first region (which may have a different composition from the part of the polymer in the second region) remains soluble in the first composition and no phase separation occurs in the first region (which is derived wholly or largely from the first curable composition).

Upon drying the solvent is removed and a polymer remains on the support, having a first (essentially non-porous) region derived wholly or largely from the first curable composition, a mixed region derived from a mixture of the first and second curable compositions and an upper (but not necessarily topmost) region derived wholly or largely from the second curable composition.

Diffusion of the first and the second curable compositions into each other to provide an inhomogeneous coating is believed to be important for obtaining an ink receptive substrate having good scratch resistance. Complete diffusion would create a homogeneous coating which might or might not phase separate. Therefore it is important to start curing while the coating is inhomogeneous, before diffusion is complete. Parameters that play a role in the extent and speed of diffusion include: the type and concentration of the curable compounds, the temperature, the depth of each curable composition, the viscosities of the first and second curable compositions and time interval between application of the curable compositions to the support and curing.

To achieve partial diffusion, generally the time between applying the curable compositions to the support and curing the compositions should be restricted. Preferably therefore step (iii) is performed within 30 seconds of step (i), more preferably within 15 seconds, even more preferably within 6 seconds, especially within 3 seconds of step (i). In a continuous process, at steady state steps (i), (ii) and (iii) are being performed simultaneously on different parts of a moving support and the abovementioned time difference between step (i) and step (iii) may be achieved by spacing apart a means for applying the first and a second curable composition to the support and a means for curing the inhomogeneous coating.

The concentration of curable compounds in the first and second curable composition is preferably at least 30 wt %, more preferably at least 35 wt % and especially at least 37.5 wt %. The upper limit of the concentration of curable compounds may be as high as 99.5 wt % as long as the composition retains a sufficiently low viscosity for it to be applied to the support as a coating, although a concentration between 30 wt % and 60 wt % is preferred.

When the ink receptive substrate is intended to be used with aqueous inks, preferably the second curable composition comprises one or more hydrophilic curable compounds because this can help the substrate to rapidly absorb aqueous inks. On the other hand, in order to achieve phase separation from an aqueous curable composition a hydrophobic polymer is desired. These seemingly contradictory demands for both hydrophilicity and hydrophobicity can be achieved for instance by including in the composition one or more amphiphilic curable compounds. Amphiphilic curable compounds may have both hydrophilic and hydrophobic groups or may have amphiphilic groups (e.g. a (1,2- or 1,3-) propylene oxide chain or a (1,2-, 1,3- or 1,4-) butylene oxide chain). Examples of hydrophobic groups include aliphatic and aromatic groups, alkyl chains longer than C3 and the like. An alternative approach is to include in the curable composition a combination of hydrophilic curable compounds and hydrophobic curable compounds. The latter method allows the properties of the resultant ink receptive substrate to be controlled by varying the ratio of both types of curable compounds.

Hydrophilic curable compounds include water-soluble monomers and monomers having hydrophilic groups such as hydroxy, carboxylate, sulfate, amine, amide, ammonium, ethylene oxide chain and the like.

Amphiphilicity can be obtained in several ways. Amphiphilic curable compounds can for instance be made by introducing a polar group (e.g. hydroxy, ether, carboxylate, sulfate, amine, amide, ammonium, etc.) into the structure of a hydrophobic curable compounds. On the other hand, starting from a hydrophilic structure, an amphiphilic curable compound can be made by increasing the hydrophobic character by introducing e.g. alkyl or aromatic groups. Good results are obtained when at least one of the curable compounds in the second curable composition has a restricted water reducibility.

Preferably the curable compound used in the second curable composition is miscible with water at 25° C. in a weight ratio of between 98/2 and 50/50, more preferably between 96/4 and 50/50, even more preferably between 90/10 and 50/50.

Many suitable curable compounds are amphiphilic in nature. A suitable concentration of the curable compound can be achieved by addition of a co-solvent, a surfactant, by adjusting the pH of the composition or by mixing in curable compounds that maintain a good solubility at higher water loads. The miscibility ratios of water with the latter monomers are typically larger than 50 wt % at 25° C. Suitable curable compounds exhibiting a miscibility with water at 25° C. in a weight ratio water/monomer between 2/98 and 50/50 include: alkylene glycol diacrylate(s), e.g. poly(ethylene glycol) diacrylate (preferably MW<500, e.g. triethylene glycol diacrylate, tetraethylene glycol diacrylate, etc.), ethylene glycol epoxylate dimethacrylate, glycerol diglycerolate diacrylate, propylene glycol glycerolate diacrylate, tripropylene glycol glycerolate diacrylate, oligo(propylene glycol) diacrylate, poly(propylene glycol) diacrylate, oligo(propylene glycol) glycerolate diacrylate, poly(propylene glycol) glycerolate diacrylate, oligo(butylene oxide) diacrylate, poly(butylene oxide) diacrylate, oligo(butylene oxide) glycerolate diacrylate, poly(butylene oxide) glycerolate diacrylate, ethoxylated trimethylolpropane triacrylate (ethoxylation 3-10 mol), ethoxylated bisphenol-A diacrylate (ethoxylation 3-10 mol), 2-hydroxy ethyl acrylate, 2-hydroxypropylacrylate, 2-hydroxy-3-phenoxy propyl acrylate, 2-(ethoxyethoxyl)ethylacrylate, N,N′-(r[alpha])ethylene-bis(acrylamide). Also suitable are commercially available curable compounds such as CN129 (an epoxy acrylate), CN131B (a monofunctional aliphatic epoxy acrylate), CN 133 (a trifunctional aliphatic epoxy acrylate), CN9245 (a trifunctional urethane acrylate), CN3755 (an amino diacrylate) and CN371 (an amino diacrylate), all from Cray Valley. France.

Suitable (hydrophilic) curable compounds having a good miscibility with water (weight ratio water/monomer larger than 50/50 at 25° C.) include: alkylene glycol diacrylate(s), e.g. poly(ethylene glycol) (meth)acrylates (preferably MW>500) and poly(ethylene glycol) di(meth)acrylates (preferably MW>500); ethoxylated trimethylolpropane triacrylates (ethoxylation more than 10 mol); (meth) acrylic acid; (meth)acrylamide; 2-(dimethylamino)ethyl (meth)acrylate; 3-(dimethylamino)propyl (meth)acrylate; 2-(diethylamino)ethyl (meth)acrylate; 2-(dimethylamino)ethyl (meth)acrylamide; 3-(dimethylamino)propyl (meth)acrylamide; 2-(dimethylamino)ethyl (meth)acrylate quartenary ammonium salt (chloride or sulfate); 2-(diethylamino)ethyl (meth)acrylate quartenary ammonium salt (chloride or sulfate); 2-(dimethylamino)ethyl (meth)acrylamide quartenary ammonium salt (chloride or sulfate); and 3-(dimethylamino)propyl (meth)acrylamide quartenary ammonium salt (chloride or sulfate).

Preferred alkylene glycol diacrylate(s) are of the Formula (I):

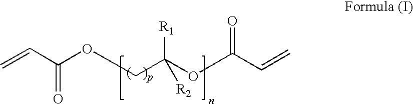

wherein:
each p independently is 1 to 5;

n is at least 1; and

each R₁ and R₂ independently is H, methyl or ethyl.

Preferably n is 1 to 12, more preferably 1 to 8, especially 2 to 7.

Preferred alkylene glycol groups are of the formula —((C_{q}H_{2q})O)ᵣ— wherein q is 2, 3 or 4 (preferably 2) and r is from 1 to 8. Thus preferred alkylene glycol diacrylate(s) are of the formula H₂C═CHCO—O—((C_{q}H_{2q})O)ᵣ—COCH═CH₂ wherein q and r are as hereinbefore defined.

Examples of suitable alkylene glycol diacrylate(s) include ethylene glycol diacrylate, di(ethylene glycol) diacrylate, tri(ethylene glycol) diacrylate, tetra(ethylene glycol) diacrylate, poly(ethylene glycol) diacrylate wherein the average number of ethylene glycol groups is 8 or less, di(propylene glycol) diacrylate, tri(propylene glycol) diacrylate, di(tetramethylene glycol) diacrylate, 1,3-butylene glycol diacrylate, 1,4-butanediol diacrylate, neopentyl glycol diacrylate, 1,6-hexanediol diacrylate and alkoxylated hexanediol diacrylate. Mixtures of these diacrylates may also be used. Commercial examples of suitable monomers are for example ethylene diacrylate (e.g. from AcrosOrganics. Belgium), triethylene glycol diacrylate (e.g. from Dayang Chemicals Co., China), tetra ethylene glycol diacrylate (e.g. from Leputech. China), polyethylene glycol 200 diacrylate (e.g. SR259 from Sartomer. France); poly tetramethylene glycol diacrylate (e.g. from Kyoeisha Chemical, Japan), dipropylene glycol diacrylate (e.g. SR508 from Sartomer. France), tripropylene glycol diacrylate (e.g. from Dayang Chemicals Co., China). In some cases the commercially available products are not a single pure compound but a mixture of compounds varying in number of alkylene glycol groups. Such mixtures are also suitable for use in the current invention.

Suitable (hydrophobic) curable compounds having a poor miscibility with water (weight ratio water/monomer smaller than 2/98 at 25° C.) include: alkyl (meth)acrylates (e.g. ethyl acrylate, n-butyl acrylate, n-hexylacrylate, octylacrylate, laurylacrylate), aromatic acrylates (phenol acrylate, alkyl phenol acrylate, etc.), aliphatic diol (di) (meth)acrylates (e.g. 1,4-butanediol diacrylate, 1,6-hexanediol diacrylate, Hydroxypivalic acid neopentylglycol diacrylate, neopentylglycol diacrylate, tricyclodecanedimethanol diacrylate), trimethylolpropane triacrylate, glyceryl triacrylate, pentaerythitol triacrylate, pentaerythitol tetraacrylate, dipentaerythritol pentaacrylate, dipentaerythritol hexaacrylate, ditrimethylolpropane tetraacrylate, styrene derivatives, divinylbenzene, vinyl acetate, vinyl alkyl ethers, alkene, butadiene, norbonene, isoprene, polyester acrylates having alkyl chain longer than C₄, polyurethane acrylates having alkyl chain longer than C₄ and polyamide acrylates having alkyl chain longer than C₄.

Preferably 1 to 100 wt % of the curable compounds used in the second curable composition are miscible with water in a ratio water/curable compound of between 2/98 and 50/50 at 25° C., more preferably between 10 to 80 wt %, most preferably between 40 to 70 wt %, based on the total weight of curable compounds in the second composition.

The higher miscibilities and higher contents of miscible curable compounds are more preferred in the first curable composition than the second curable composition due to the desire for phase separation in the second region but not in the first region.

In principle (electromagnetic) radiation of any suitable wavelength can be used to cure the inhomogeneous coating, for example ultraviolet, visible or infrared radiation. Polymerization initiators or free radical initiators may be included to initiate the polymerization reaction upon irradiation of the curable composition. Advantages of free radical polymerization are the high reaction rate and the flexibility; chemical polymerization requires thorough mixing of the cross-linking agent and is usually much slower. Initiators can be mixed into the compositions containing curable compound(s), preferably prior to applying the compositions to the support. Photo-initiators are usually required when the coating is cured by UV or visible light radiation. Suitable photo-initiators are those known in the art such as radical type, cation type or anion type photo-initiators.

Examples of radical type I photo-initiators are as described in WO2007/018425, page 14, line 23 to page 15, line 26, which are incorporated herein by reference thereto.

Examples of radical type II photo-initiators are as described in WO2007/018425, page 15, line 27 to page 16, line 27, which are incorporated herein by reference thereto.

For (meth)acrylates, di(meth)acrylates and poly(meth)acrylates (these are curable compounds), type I photo-initiators are preferred. Especially alpha-hydroxyalkylphenones, such as 2-hydroxy-2-methyl-1-phenyl propan-1-one, 2-hydroxy-2-methyl-1-(4-tert-butyl-) phenylpropan-1-one, 2-hydroxy-[4″-(2-hydroxypropoxy)phenyl]-2-methylpropan-1-one, 2-hydroxy-1-[4-(2-hydroxyethoxy)phenyl]-2-methylpropan-1-one, 1-hydroxycyclohexylphenylketone and oligo[2-hydroxy-2-methyl-1-{4-(1-methylvinyl)phenyl}propanone], alpha-aminoalkylphenones, alpha-sulfonylalkylphenones and acylphosphine oxides such as 2,4,6-trimethylbenzoyl-diphenylphosphine oxide, ethyl-2,4,6-trimethylbenzoyl-phenylphosphinate and bis(2,4,6-trimethylbenzoyl)-phenylphosphine oxide, are preferred.

Preferably the ratio of photo-initiator to curable compound(s) is between 0.0001 and 0.1 wt %, more preferably between 0.001 and 0.05 wt %, based on the total weight of curable compound(s) in the composition. A single type of photo-initiator may be used but also a combination of several different types.

Cationic photo-initiators are particularly suitable when any of the curable compounds have epoxy, oxetane or other ring opening heterocyclic groups or vinyl ether groups. Preferred cationic photo-initiators are organic salts of non-nucleophilic anions such as hexafluoroarsinate ion, antimony(V) hexafluoride-ion, phosphorus hexafluoride-ion and tetrafluoroborate ion. Commercially available examples include UVI-6974, UVI-6970, UVI-6990 (manufactured by Union Carbide Corp.), CD-1010, CD-1011, CD-1012 (manufactured by Sartomer Corp.), Adekaoptomer SP-150, SP-151, SP-170, SP-171 (manufactured by Asahi Denka Kogyo Co., Ltd.), Irgacure 261 (Ciba Specialty Chemicals Corp.), CI-2481, CI-2624, CI-2639, CI-2064 (Nippon Soda Co., Ltd.), DTS-102, DTS-103, NAT-103, NDS-103, TPS-103, MDS-103, MPI-103 and BBI-103 (Midori Chemical Co., Ltd.). The above mentioned cationic photo-initiators can be used either individually or in combination of two or more. The most preferred cationic photoinitiator is a triarylsulfonium hexafluoroantemonate, e.g. UVI-6974 (from Union Carbide).

When UV radiation is used for curing, a UV light source can be selected having emissions at several wavelengths. The combination of UV light source and photo-initiator(s) can be optimized so that sufficient radiation penetrates the inhomogeneous coating to activate the photo-initiators. A typical example is an H-bulb with an output of 600 Watts/inch (240 W/cm) as supplied by Fusion UV Systems which has emission maxima around 220 nm, 255 nm, 300 nm, 310 nm, 365 nm, 405 nm, 435 nm, 550 nm and 580 nm. Alternatives are the V-bulb and the D-bulb which have a different emission spectrum.

To reach the desired dose of radiation to cure the inhomogeneous coating at high coating speeds, step (iii) optionally comprises irradiation of the inhomogeneous, curable coating with more than one UV lamp. When two or more UV lamps are used the lamps may apply an equal dose of UV light or they may apply different doses of UV light. For instance, a first lamp may apply a higher or lower dose to the inhomogeneous, curable coating than a subsequent lamp. When more than one such UV lamp is used the lamps may emit the same or different wavelengths of light. The use of different wavelengths of light an be advantageous to achieve good curing properties, for example when one lamp emits light of a wavelength which achieves a good surface cure and another lamp emits light of a wavelength which achieves a good cure depth, in combination with suitable photoinitiators

Preferably the UV light source and the photo-initiators are chosen such that the wavelength of the UV light provided corresponds to the absorption of the photo initiator(s). From a choice of light sources and photo-initiators optimal combinations can be made. Applying multiple types of photo-initiator allows for thicker layers to be cured efficiently with the same intensity of irradiation.

When no photo-initiator is included in either or both of the curable compositions, curing may be performed by electron-beam exposure, e.g. using an exposure of 50 to 300 keV. Curing can also be achieved by plasma or corona exposure.

Curing rates may be increased by including amine synergists in the curable compositions. Suitable amine synergists are e.g. free alkyl amines such as triethylamine, methyldiethanol amine, triethanol amine; aromatic amine such as 2-ethylhexyl-4-dimethylaminobenzoate, ethyl-4-dimethylaminobenzoate and also polymeric amines as polyallylamine and its derivatives. Curable amine synergists such as ethylenically unsaturated amines (e.g. (meth)acrylated amines) are preferable since their use will give less odour due to their ability to be incorporated into the polymer by curing. The amount of amine synergists is preferably from 0.1-10 wt % based on the total weight of curable compounds in the composition, more preferably from 0.3-3 wt %.

Where desired, a surfactant or combination of surfactants may be included in one or both of the curable compositions as a wetting agent or to adjust surface tension. Commercially available surfactants may be utilized, including radiation-curable surfactants. Surfactants suitable for use in the curable compositions include non-ionic surfactants, ionic surfactants, amphoteric surfactants and combinations thereof.

Preferred surfactants are as described in WO2007/018425, page 20, line 15 to page 22, line 6, which are incorporated herein by reference thereto. Fluorosurfactants are particularly preferred, especially Zonyl® FSN (produced by E.I. Du Pont).

Preferably the ink receptive substrate has a light transmittance of at least 10%.

Preferably the ink receptive substrate has a scratch resistance of at least 100 g when measured by a Scratching Intensity Tester Heidon 18.

Preferably the support comprises a gelatin coating. In this way the adhesion and scratch resistance of the ink receptive substrate is enhanced still further. Any type of gelatin may be used, for example alkali-treated gelatine (cattle bone or hide gelatin), acid-treated gelatine (pigskin gelatin), chemically modified gelatins such as acetylated gelatin, phthalated gelatin, alkyl quaternary ammonium modified gelatin, succinated gelatin, alkylsuccinated gelatin, gelatin modified with N-hydroxysuccinimide ester of fatty acid and mixtures thereof.

In a preferred embodiment the support comprises gelatin coating and the first curable composition comprises a curable compound having at least one hydroxy group. This combination can result in particularly good scratch resistance.

One or more fillers may be included in the compositions if desired, e.g. to enhance their whiteness and/or impart further porosity. Both organic and inorganic particles can be used as fillers. Useful fillers are for example, silica (colloidal silica), alumina or alumina hydrate (aluminazol, colloidal alumina, a cation aluminium oxide or its hydrate and pseudo-boehmite), a surface-processed cat ion colloidal silica, aluminium silicate, magnesium silicate, magnesium carbonate, titanium dioxide, zinc oxide, calcium carbonate, kaolin, talc, clay, zinc carbonate, satin white, diatomaceous earth, synthetic amorphous silica, aluminium hydroxide, lithopone, zeolite, magnesium hydroxide and synthetic mica. Among these inorganic fillers, porous inorganic fillers are preferable such as porous synthetic silica, porous calcium carbonate and porous alumina. Useful examples of organic fillers are represented by polystyrene, polymethacrylate, polymethyl-methacrylate, elastomers, ethylene-vinyl acetate copolymers, polyesters, polyester-copolymers, polyacrylates, polyvinylethers, polyamides, polyolefines, polysilicones, guanamine resins, polytetrafluoroethylene, elastomeric styrene-butadiene rubber (SBR), urea resins, urea-formalin resins. Such organic and inorganic fillers may by used alone or in combination.

If desired one or mordants may be included in one or both of the curable compositions, especially the second curable composition, in order to help fix colorants contained in inks. Colorants used in inkjet printers typically have anionic groups, e.g. carboxy and/or sulpho groups. Therefore the second curable composition preferably contains a cationic mordant.

Preferred mordants are organic or inorganic, or a mixture of an organic and inorganic mordants may be used.

Preferred organic cationic mordants are curable, for example they contain an amino or quaternary ammonium group and one or more polymerisable groups. Examples of such mordants include alkyl- or benzyl ammonium salts comprising one or more polymerisable groups such as a vinyl, (di)allyl, (meth)acrylate, (meth)acrylamide and/or (meth)acryloyl group.

Preferred inorganic mordants include polyvalent water-soluble metal salts and hydrophobic metal salts, especially aluminium-containing compounds, titanium-containing compounds, zirconium-containing compounds and salts metals in the series of Group IHB in the periodic table (salt or complex).

The amount of mordant included in the curable composition(s) is preferably selected to provide a concentration in the final ink receptive substrate of 0.01 to 5 g/m², more preferably 0.1 to 3 g/m².

The support is preferably a transparent or translucent material. Examples of suitable supports include polyesters (e.g. polyethylene terephthalate), polyethylene naphthalate, triacetate cellulose, polysulfone, polyphenylene oxide, polyethylene, polypropylene, polyvinylchloride, polyimide, polycarbonate, polyamide and the like. Other materials that may be used as support are glass, polyacrylate and the like. Inter alia, polyesters are preferable, and polyethylene terephthalate is particularly preferable.

The thickness of the support is not particularly limited, however 50 to 200 microns is convenient from the viewpoint of handling.

A second aspect of the present invention provides an ink receptive substrate obtained by a process according to the first aspect of the present invention.

A third aspect of the present invention provides a process for forming an image on a substrate comprising applying an ink to an ink receptive substrate according to the second aspect of the present invention.

The ink receptive substrate of the invention is particularly suitable for use in large format printers.

While aqueous inks may be used in the third process, preferred inks are solvent-based inks (including eco-solvent inks), UV curable inks (especially non-aqueous UV curable inks) and oil-based inks. Suitable UV curable and solvent-based inks may be obtained from FUJIFILM Sericol, e.g. under the trade names Uvijet™ and Color+™ respectively.

Aqueous inks preferably comprise one or more colorants, water and one or more water-miscible organic solvents. Examples of water-miscible organic solvents are as described above. Suitable colorants are pigments and dyes, especially those which carry one or more anionic group (e.g. sulpho and/or carboxy groups).

Preferably the ink is applied to the substrate using an ink jet printer, especially a thermal or piezo ink jet printer.

A fourth aspect of the present invention provides a printed ink receptive substrate according to the second aspect of the present invention.

A fifth aspect of the present invention provides a light box comprising a frame defining a window, a light source and a printed ink receptive substrate, wherein the ink receptive substrate is as defined in the second aspect of the present invention.

The invention is now illustrated by the following non-limiting examples in which all parts and percentages are by weight unless otherwise specified.

The following abbreviations are used in the examples:

| Abbreviation | Meaning |
|---|---|
| SR259 | PEG 200 diacrylate, from Sartomer. |
| IPA | Propan-2-ol. |
| DAA | Diacetone alcohol (4-hydroxy-4-methyl-2-pentanone). |
| TEA | Triethylamine. |
| Irgacure ™ 1800 | A photoinitiator from Ciba (a 75:25 mixture of Bis(2,6- |
| | dimethoxybenzoyl)-2,4,4-trimethyl-pentylphosphineoxide and 1- |
| | Hydroxy-cyclohexyl-phenyl-ketone). |
| Zonyl ™ | A fluoro surfactant from DuPont. |
| FSN100 | |
| SR344 | PEG 400 diacrylate, from Sartomer. |
| SR610 | PEG 600 diacrylate, from Sartomer. |
| CN435 | Ethoxylated (15 mole) trimethylolpropane triacrylate from |
| | Sartomer. |
| CN132 | An aliphatic epoxy diacrylate from Sartomer. |
| SR502 | Ethoxylated (9 mole) trimethylolpropane triacrylate from |
| | Sartomer. |
| G-EP-DA | Glycerol 1,3-diglycerolate diacrylate, from Sigma-Aldrich |
| Irgacure ™ 2959 | A photoinitiator from Ciba (1-[4-(2-Hydroxyethoxy)-phenyl]-2- |
| | hydroxy-2-methyl-1-propane-1-one). |
| Irgacure ™ 1870 | A photoinitiator from Ciba. |
| TPO-L | Ethyl-2,4,6-trimethylbenzoylphenylphosphinate, a photoinitiator from |
| | BASF. |
| Omnirad ™ 102 | 2-hydroxy-2-methyl-1-(4-tert-butyl)phenyl propanone, a |
| | photoinitiator from IGM Resins. |

In the Examples the first curable composition was varied as described below, or in the case of Comparative Example 1 it was omitted altogether.

The second curable composition had the following formulation:

| Component | Weight (g) |
|---|---|
| SR259 | 37.5 |
| Propan-2-ol | 17.7 |
| Irgacure ™ 1800 | 0.80 |
| water | 44.0 |
| Total | 100 |

The third curable composition had the following formulation:

| Component | Weight (g) |
|---|---|
| SR259 | 37.6 |
| Propan-2-ol | 14.8 |
| Irgacure ™ 1800 | 0.4 |
| water | 34.3 |
| Zonyl ™-FSN-100 (3% solution) | 12.9 |
| Total | 100 |

Scratch Resistance was measured using a ‘Scratching Intensity Tester Heidon 18’ from Heidon Co, Japan. A stainless steel needle with a tip diameter of 0.1 mm was placed on the sample under test and different, increasing weights were placed on the needle. The samples were transported at a speed of 10 mm/sec while the weighted needle was resting on the sample. The scratch resistance was the weight at which the white porous layer was substantially removed by the needle and the underlying transparent support became visible. At lower weights a slight surface scratch in the porous layer was visible in some cases. In these experiments a good scratch resistance was deemed to be a value>100 g.

### EXAMPLES 1 TO 17 AND COMPARATIVE EXAMPLES 1 to 2

Examples 1 to 17 were prepared by applying curable compositions to a support using the general method described below:

A length of support (clear PET film treated by corona discharge and having a gelatin coating, obtained from Agfa, Belgium) was wound onto a first spool. The support moved at a speed of 30 m/min onto a second spool. The first and second curable composition (the latter having the formulation described above) were applied contemporaneously and continuously to the moving support. In addition a third curable composition (having the formulation described above) was applied to the support contemporaneously with the first and second curable compositions. All three curable compositions were applied by means of composition application station comprising a slide bead coating machine using three slots. The first slot applied the first composition to the support in a (wet) amount of 16 g/m², the second slot applied the second composition to the support in a (wet) amount of 75 g/m² and the third curable composition was applied as a top layer in a (wet) amount of 15 g/m².

The coated support passed under an irradiation source (a Light Hammer LH6 from Fusion UV Systems fitted with a D-bulb, working at 67% intensity) positioned 1.2 metres (=2.4 seconds) downstream of the slide bead coater and then to a drying region. The dried, ink receptive substrate than traveled to the collecting station comprising the second spool.

The first curable composition used in the Examples and Comparative Example 2 were as indicated in Tables 1, 2 and 3 below where the numbers relate to the weight in grams of the respective component. In C1 (comparative Example 1) the first curable composition was omitted entirely, but the second curable composition was applied to the support in a (wet) amount of 91 g/m². In C2 (comparative Example 2) instead of contemporaneously applying the first, second and third curable compositions the first composition was applied, then cured, before contemporaneously applying the second and third curable compositions (both of which phase separate).

The scratch resistance of the Examples and Comparative Examples in scratch weight (g) is shown as the bottom row in Tables 1, 2 and 3:

TABLE 1

| | Example | | | | | | | |
|---|---|---|---|---|---|---|---|---|
| Component | 1 | 2 | 3 | 4 | 5 | 6 | C1 | C2 |
| SR259 | | | | 38.9 | | | — | |
| SR344 | | | | | | 38.9 | — | |
| SR610 | | | | | 38.9 | | — | |
| CN435 | | | | | | | — | |
| CN132 | 38.9 | 38.9 | 38.9 | | | | — | 38.9 |
| IPA | 24.5 | 24.5 | 24.5 | 30.0 | 20.8 | 24.2 | — | 24.5 |
| Irgacure ™ 1800 | | 0.60 | | 0.60 | 0.60 | 0.60 | — | 0.60 |
| Irgacure ™ 2959 | | | 1.20 | | | | — | |
| Irgacure ™ 1870 | 0.6 | | | | | | — | |
| water | 36.0 | 36.0 | 35.4 | 30.5 | 39.7 | 36.3 | — | 36.0 |
| Total | 100 | 100 | 100 | 100 | 100 | 100 | — | 100 |
| Scratch Resistance | 180 | 175 | 185 | 140 | 110 | 110 | 60 | 60 |

Note:
In C1 the first curable composition was not applied, instead only the second and third curable compositions were applied (both of which phase separate). In C2 the first composition did not phase separate, however it was applied contemporaneously with the second curable composition - instead the first curable composition was cured before the second and third curable compositions were applied (both of which phase seperate).

From C1 (FIG. 5) the porosity of the second region is estimated directly since little if any interference from the first curable composition occurred (the composition of the third curable composition is almost identical to that of the second curable composition so it is assumed that the combination has lead to the same porosity as a single second curable composition would have).

The % porosity is calculated as follows:

% porosity=(DT/CA×100%)−100%

wherein:

DT is the dry thickness of the resultant, cured polymer in micrometers; and

CA is the coated amount of non-volatile compounds in grams per m².

The coated amount of non-volatile compounds in the second and third curable compositions (CA) was 40.6 g/m².

The dry thickness (DT) was 55 micrometers

Therefore porosity of the polymer at its surface furthest away from the support was ((55/40.6×100%)−100%)=35%.

TABLE 2

| | Example | | | | | | | | |
|---|---|---|---|---|---|---|---|---|---|
| Component | 7 | 8 | 9 | 10 | 11 | 12 | 13 | 14 | 15 |
| SR259 | | | | 19.3 | 19.3 | 19.3 | 38.5 | 38.5 | 38.5 |
| CN132 | 38.5 | 38.5 | 38.5 | 19.3 | 19.3 | 19.3 | | | |
| IPA | 25.8 | 23.7 | 19.6 | 28.7 | 26.3 | 21.6 | 31.5 | 26.2 | 23.6 |
| Irgacure ™ 1800 | 0.60 | 0.60 | 0.60 | 0.60 | 0.60 | 0.60 | 0.60 | 0.60 | 0.60 |
| Water | 35.0 | 37.1 | 41.2 | 32.2 | 34.5 | 39.2 | 29.3 | 34.7 | 37.2 |
| Total | 100 | 100 | 100 | 100 | 100 | 100 | 100 | 100 | 100 |
| Scratch Resistance | 180 | 180 | 150 | 140 | 130 | 130 | 130 | 130 | 100 |

TABLE 3

Example

| Component | 16 | 17 |
|---|---|---|
| SR502 | 40.0 | 0 |
| G-EP-DA | 0 | 40.0 |
| IPA | 30.1 | 30.1 |
| Irgacure ™ 1800 | 0.60 | 0.60 |
| Irgacure ™ 2959 | 0 | 0 |
| Water | 29.3 | 29.3 |
| Total | 100 | 100 |
| Scratch Resistance | 130 | 150 |

### EXAMPLE 18

The method of Examples 1 to 17 was repeated except that: (a) four (instead of applying three) curable compositions were simultaneously applied to the support using four slots of a slide bead coater; and (b) curing was performed using two different UV lamp in sequence; and (c) the support was moving at a speed of 45 m/min.

The first curable composition (closest to the support) had the following formulation:

| Component | Weight (g) |
|---|---|
| SR259 | 40.0 |
| DAA | 32.7 |
| TPO-L | 0.60 |
| water | 26.7 |
| Total | 100 |

The next (second) curable composition had the following formulation:

| Component | Weight (g) |
|---|---|
| SR259 | 37.5 |
| DAA | 22.7 |
| TPO-L | 0.60 |
| water | 39.2 |
| Total | 100 |

The next (third) curable composition had the following formulation:

| Component | Weight (g) |
|---|---|
| SR259 | 37.5 |
| DAA | 22.7 |
| Omnirad ™ 102 | 1.20 |
| water | 38.6 |
| Total | 100 |

The topmost (fourth) curable composition had the following formulation:

| Component | Weight (g) |
|---|---|
| SR259 | 37.1 |
| DAA | 22.7 |
| Omnirad ™ 102 | 0.5 |
| TEA | 1.0 |
| water | 25.8 |
| Zonyl ™-FSN-100 (3% solution) | 12.9 |
| Total | 100 |

The wet amounts of the four curable compositions applied to the support were 16 g/m², 36 g/m², 36 g/m² and 15 g/m² respectively.

The first UV lamp was positioned 3 metres downstream of the slide bead coater and irradiated the curable compositions 4 seconds after they had been applied to the support. This UV lamp was a Light Hammer LH10 from Fusion UV Systems, fitted with a D-bulb, working at 100% intensity.

The second UV lamp was positioned 3.2 metres downstream of the slide bead coater and irradiated the curable compositions 4.3 seconds after they had been applied to the support. This second UV lamp was a Light Hammer LH10 from Fusion UV Systems, fitted with a H-bulb, working at 100% intensity. Subsequently the ink receptive substrate comprising the cured composition was transported to a drying region.

The resultant ink receptive substrate comprised an ink receptive layer having good adhesion to the support and good scratch resistance (180 g as measured by the method described above).

1. A process for preparing an ink receptive substrate comprising the steps of:
(i) contemporaneously applying a first and a second curable composition to a support such that the first composition is closer to the support than the second composition;
(ii) allowing the first and second compositions to diffuse into each other to provide an inhomogeneous, curable coating on the support; and
(iii) curing the inhomogeneous coating to form a polymer layer having a lower porosity nearer the support than further away from the support.

2. A process according to claim 1 wherein the first curable composition is a curable composition which does not phase separate when cured in the absence of the second curable composition and the second curable composition is a curable composition which does phase separate when cured in the absence of the first curable composition.

3. A process according to claim 1 wherein the first curable composition comprises at least 5 wt % more organic solvent than the second curable composition, relative to the total weight of the composition.

4-15. (canceled)

16. A process according to claim 1 wherein when the part of the ink receptive layer derived from where the compositions have diffused into each other, hereinafter abbreviated as the mixed region, has a gradual porosity gradient with porosity increasing as the distance from the support increases.

17. A process according to claim 1 wherein:
a. the first curable composition is a curable composition which does not phase separate when cured in the absence of the second curable composition and the second curable composition is a curable composition which does phase separate when cured in the absence of the first curable composition; and
b. the first curable composition comprises at least 5 wt % more organic solvent than the second curable composition, relative to the total weight of the composition.

18. A process according to claim 1 wherein the porosity of the polymer at its surface in contact with the support is below 15%.

19. A process according to claim 1 wherein the porosity of the polymer at its surface furthest away from the support is greater than 15%.

20. A process according to claim 17 wherein:
c. the porosity of the polymer at its surface in contact with the support is below 15%; and
d. the porosity of the polymer at its surface furthest away from the support is greater than 15%.

21. A process according to claim 1 wherein the ink receptive substrate has a scratch resistance of at least 100 g when measured by a Scratching Intensity Tester Heidon 18.

22. A process according to claim 20 wherein the ink receptive substrate has a scratch resistance of at least 100 g when measured by a Scratching Intensity Tester Heidon 18.

23. A process according to claim 2 wherein the first and/or second curable composition comprise an alkylene glycol diacrylate according Formula (I): 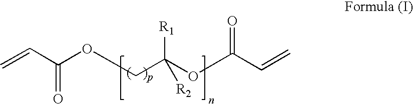
wherein:
each p independently is 1 to 5;
n is 1 to 12; and
each R₁ and R₂ independently is H, methyl or ethyl.

24. A process according to claim 20 wherein the first and/or second curable composition comprise an alkylene glycol diacrylate according Formula (I): 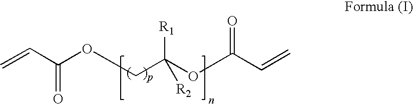
wherein:
each p independently is 1 to 5;
n is 1 to 12; and
each R₁ and R₂ independently is H, methyl or ethyl.

25. A process according to claim 2 which is performed using a coating machine operating at a coating speed of over 15 m/min.

26. A process according to claim 17 which is performed using a coating machine operating at a coating speed of over 15 m/min.

27. A process according to claim 20 which is performed using a coating machine operating at a coating speed of over 15 m/min.

28. An ink receptive substrate obtained by a process according to claim 2.

29. An ink receptive substrate obtained by a process according to claim 20.

30. An ink receptive substrate obtained by a process according to claim 24.

31. A process for forming an image on a substrate comprising applying an ink to an ink receptive substrate as defined in claim 28 by means of an ink jet printer.

32. A process for forming an image on a substrate comprising applying an ink to an ink receptive substrate as defined in claim 29 by means of an ink jet printer.

33. A process for forming an image on a substrate comprising applying an ink to an ink receptive substrate as defined in claim 30 by means of an ink jet printer.

34. A light box comprising a frame defining a window, a light source and a printed ink receptive substrate, wherein the ink receptive substrate is as defined in claim 31.

35. A light box comprising a frame defining a window, a light source and a printed ink receptive substrate, wherein the ink receptive substrate is as defined in claim 32.

36. A light box comprising a frame defining a window, a light source and a printed ink receptive substrate, wherein the ink receptive substrate is as defined in claim 33.
